(19) United States
(12) Patent Application Publication
(10) Pub. No.: US 2004/0214718 A1
(43) Pub. Date: Oct. 28, 2004

(54) Inorganic intercalating nano-catalyst for the fixation of carbon dioxide into aliphatic polycarbonate and a process for preparing the same

(75) Inventors: Yuezhong Meng, Guangzhou (CN); Xiuhua Li, Guangzhou (CN); Quan Zhu, Guangzhou (CN); Min Xiao, Guangzhou (CN); Jintao Wang, Guangzhou (CN); Xialian Lu, Guangzhou (CN); Min Cao, Guangzhou (CN)

Correspondence Address: GREER, BURNS & CRAIN, 300 S WACKER DR, 25TH FLOOR, CHICAGO, IL, 60606, US

(73) Assignee: Sun Yat-Sen University

(21) Appl. No.: 10/803,310

(22) Filed: Mar. 18, 2004

(30) Foreign Application Priority Data
Apr. 25, 2003 (CN) 03114303.2

(51) Int. Cl. B01J 31/00

(52) U.S. Cl. 502/170

(57) ABSTRACT

The present invention relates to an inorganic intercalating nano-catalyst with high activity for the copolymerization of carbon dioxide and epoxide. Said catalyst was prepared by intercalating zinc dicarboxylate into layered silicate. The zinc dicarboxylates were synthesized from zinc oxide and dicarboxylic acids. The silicate was activated at 600-1000° C. in a muffle furnace for a period 2˜10 h prior to intercalation. Zinc dicarboxylates were dissolved in strong polar solvents under pH value from 1.0 to 4.0. Calcinated acidic silicate was introduced into the reaction system to perform the intercalation 30˜120 minutes at the temperature from room temperature to 80° C. The crystal of the intercalating nano-catalysts was improved by refluxing in weak polar solvent followed by removing the solvent.

### TECHNICAL FIELD OF THE INVENTION

The present invention relates to an inorganic intercalating nano-catalyst with high activity useful in the synthesis of poly(alkylene carbonate)s by the copolymerization of carbon dioxide and epoxide.

The present invention also relates to a method for preparing the inorganic intercalating nano-catalyst.

### BACKGROUND OF THE INVENTION

Climate warming or the greenhouse effect is mainly attributed to the mass release of carbon dioxide (CO₂) to the atmosphere. It is estimated that carbon dioxide contributes about 66% of the climate warming. The CO₂ level in atmosphere is now reported to be about 345 ppmv (parts per million by volume), and annually increases at a rate of about 1 ppmv due to human activities, especially for the case of using mineral fuel. As an effective approach to reduce the release of greenhouse gas, the utilization of CO₂ has attracted increasing attention recently. Among these, the use of CO₂ as a polymerization monomer is of practical importance. Aliphatic polycarbonates or the block copolymers of polycarbonate and polyether can be prepared via the direct copolymerization of CO₂ with epoxide such as ethylene oxide (EO), propylene oxide (PO), isobutylene oxide (BO), and cyclohexene oxide (CHO). The copolymerization of carbon dioxide with epoxide to produce poly(alkylene carbonate)s was first reported by Inoue and co-workers (Polymer Letters 7, 287(1969); Makromol Chem130,210(1969) ); and described in U.S. Pat. No. 3,585,168. Other processes were described in U.S. Pat. Nos. 3,900,424; 3,953,383, 4,268,684 and 3,248,415 respectively. However, the progress for the commercialization of these poly(alkylene carbonate)s has been very slow, although there are numerous economic advantages associated with the use of an abundant, low cost material like carbon dioxide. The main reason lies with the practical difficulty in preparing large scale organometallic catalysts for commercial usage.

The catalysts reported by Inoue were prepared by reacting diethylzinc with compounds containing active protons, e.g., water, dicarboxylic acids, or dihydric phenols. Typical catalytic activities ranged from 3.8 to 18.9 g polymer/g zinc, and most of the yields fall at the low end of this range. Long polymerization periods of 24 to 48 h were required in order to achieve satisfactory yields and higher molecular weights of the products. It should note that the Inoue catalysts also generated noticeable amounts of by-products or cyclic carbonate and polyether homopolymer that must be removed from the desired polycarbonate products.

Zinc carboxylates have also been described as effective catalysts for CO₂ polymerization. Because zinc carboxylates are stable and safe compounds having no handling problem when comparing with diethylzinc, therefore they are promising candidates as practical and commercial catalyst systems. Soga and co-workers reported that the reaction products of zinc hydroxide and aliphatic dicarboxylic acids exhibited high activity for the copolymerization of carbon dioxide and propylene oxide (Polymer J. 13(4), 407(1981) ). A variety of acids were investigated, but only adipic and glutaric acid produced the catalysts with higher activity than the known diethylzinc catalysts. Catalysts prepared from aromatic dicarboxylic acids were essentially inert under the polymerization conditions described by Soga.

Soga also reported another approach to improve the catalytic activity by supporting the catalyst on an inert Oxide Carrier (Nippon Kagakkaishi 2, 295(1982) ). A supporting material can increase the surface area of active catalyst, thereby enhancing the efficiency production of the aliphatic polycarbonate. However, the supported catalysts of Soga were ineffective compared to the well-known diethylzinc based catalysts.

The metal salts of acetic acid are the third type of catalyst materials known to promote the copolymerization of CO₂ with epoxides (Soga et al., Makromol. Chem. 178, 893(1977) ). Only zinc and cobalt can produce alternating copolymers from CO₂ and epoxides, and the activity of these catalysts remained lower than that derived from diethylzinc catalysts.

In U.S. Pat. 4,783,445, Sun reported that soluble zinc catalysts can be prepared by reacting zinc oxide or zinc salts with a dicarboxylic acid anhydride or monoester in a suitable solvent such as the lower alcohols, ketones, esters and ethers. However, low catalytic activity was produced.

In previous work of U.S. Pat. No. 0,134,740 Al, we provided a supported catalyst with high activity useful on the synthesis of poly(alkylene carbonate)s derived by the copolymerization of CO₂ and epoxides. The highest catalytic activity in that patent is 358.8 g polymer/g zinc. Therefore this kind of catalyst is potential for a commercial practical use.

Among the catalysts reported in the literature up to that time, only zinc carboxylates and supported zinc carboxylates based on adipic or glutaric acid seem potential for practical use on a commercial scale.

### BRIEF SUMMARY OF THE INVENTION

One objective of the present invention is to provide a process for preparing inorganic intercalating nano-catalyst comprising intercalating zinc dicarboxylate into the inorganic matrix with layered structure. The weight ratio of zinc dicarboxylate to inorganic matrix varies from 1/1 to 1/20.

Another objective of the present invention is to provide an inorganic intercalating nano-catalyst obtained by aforementioned process useful in the copolymerization of carbon dioxide and epoxides to form poly(alkylene carbonate)s. This invention provides a process for the preparation of inorganic intercalating nano-catalyst with zinc dicarboxylate as intercalating agent used for preparing copolymers from epoxides and carbon dioxide. The zinc dicarboxylates were synthesized from zinc oxide and dicarboxylic acids selected from the group consisting of either succinic acid, glutaric acid, adipic acid, pimelic acid and suberic acid. The inorganic matrices are selected from the group of layered silicates consisting of montmorillonite, mica, vermiculite, kaoline etc. The matrices were activated at 600-1000 DEG C (° C.) in a muffle furnace for 2-10 h prior to intercalation. Zinc dicarboxylates was dissolved in strong polar solvents under pH value from 1.0 to 4.0. Calcinated acidic matrix was introduced into the reaction system to perform intercalation 30˜120 minutes at the temperature from room temperature to 80° C. The solvent was removed and the crystal of the intercalating nano-catalyst was improved by refluxing in less polar solvent.

In the intercalating process, the strong polar solvents were selected from the group consisting of methanol, glycol, ethylene glycol monobutyl ether, ethylene glycol monomethyl ether, N,N′-dimethyl formamide, sulfolane, imidazole, quinoline, water and N-cyclohexyl pyrrolidine under pH value from 1.0 to 4.0. Under the help of the strong polar solvent, zinc dicarboxylate was introduced into the inter spacing of the interlayers of the inorganic matrix. Thereby increasing the surface area of catalysts and enhancing the effective production of the aliphatic polycarbonate.

In the crystal-improving process, the less polar solvents were selected from the group consisting of benzene, toluene and xylene etc. After this process, the crystal of the intercalating agent was improved and redistributed among the interlayers of the inorganic matrix. Thereby increasing the activity of the catalyst and enhancing the effective production of the aliphatic polycarbonate.

The inorganic intercalating nano-catalyst can be used for the copolymerization of CO₂ and PO. The monomers copolymerized in-situ and produced nano-composites. Experimental results showed that extremely highly catalytic activity can be achieved by using zinc glutarate, zinc adipate or zinc pimelate as intercalating agent.

A more detailed description of the invention and its methods of practice are described in the following examples. It should be understood that the present invention is not intended to limit these examples in any way.

### DETAILED DESCRIPTION OF THE INVENTION

Pretreatment of Materials

Epoxide, e.g., propylene oxide (PO) with a purity of 99.5% was purified by distillation over calcium hydride under dry nitrogen gas flow for 2 h. The as-treated PO was then stored over 4A molecular sieves prior to use. Carbon dioxide with a purity of higher than 99.8% was used as received. Dicarboxylic acids succinic acid, glutaric acid, adipic acid, pimelic acid and suberic acid were of 98.0% purity, and solvents such as toluene, methanol, acetone, methylene dichloride, were of analytical reagent grade and used without further purification. Zinc oxide of 99.99% purity was also used without further treatment.

Preparation of Zinc Dicarboxylate

Zinc dicarboxylate was synthesized from zinc oxide and dicarboxylic acid under magnetic stirring as described in the literature. Fine powders of zinc oxide were used as received without further grinding. Accordingly, to a 150 mL containing 90 mL toulene three-neck round bottom flask equipped with a magnetic stirrer, condenser, and a Dean-Stark trap were added a slight molar excess of zinc oxide. To this mixture were then introduced dicarboxylic acid, and the mixture was slowly heated up to 55-110° C. for 4 to 20 h under vigorous stirring. Upon cooling down, the resulting mixture was filtered. The resulting solids were continuously washed with acetone for several times followed by drying overnight in a vacuum oven at 100° C. The obtained zinc dicarboxylates were fine powders in white color with a high acid conversion of ≧99%.

Preparation of Inorganic Intercalating Nano-Catalysts

The preparation process of inorganic intercalating nano-catalysts involved three steps. Firstly the layered matrices were delaminated with diluted acid, then calcined at 600-1000° C. in a muffle furnace for 2˜10 h prior to intercalation. Subsequently zinc dicarboxylates were dissolved in strong polar solvents under pH value from 1.0 to 4.0, then calcinated acidic matrices were introduced into the reaction system to perform intercalation 30˜120 minutes at the temperature from room temperature to 80° C. Herein the strong polar solvents are selected from methanol, glycol, ethylene glycol monobutyl ether, ethylene glycol monomethyl ether, N,N′-dimethyl formamide, sulfolane, imidazole, quinoline, water and N-cyclohexyl pyrrolidine. Finally the solvents were removed and the crystals of the intercalating nano-catalysts were improved by refluxing in less polar solvents. Herein the less polar solvents are selected from benzene, toluene, xylene etc. The intercalating process was performed in a 150 mL single-neck round bottom flask equipped with a magnetic stirrer, condenser. The crystal-improving process was carried out with a set of refluxing equipment

Copolymerization

The copolymerization of CO₂ and epoxide, e.g. propylene oxide was carried out in a 500 mL autoclave equipped with a mechanical stirrer. Inorganic intercalating nano-catalyst was further dried at 100° C. for 24 h prior to being used for the polymerization process. Dry inorganic intercalating nano-catalyst was then introduced into the autoclave as quickly as possible. The autoclave was then capped with its head, and the entire assembly was connected to the reaction system equipped with a vacuum line. The autoclave with catalyst inside was further dried for 24 h under vacuum at 100° C. This implied that the catalyst was further in-situ dried during the same process for another 24 h. Subsequently, the autoclave was purged with carbon dioxide and evacuated alternatively for three times, followed by adding purified PO with a syringe. The autoclave was then pressurized to 5.0 MPa via a CO₂ cylinder. The copolymerization was performed at 60° C. under stirring for 40 h. The autoclave was cooled to room temperature and the pressure was released. The resulting viscous mixture was removed and poured into vigorously stirred methanol to precipitate poly (propylene carbonate) (PPC) The as-made PPC was filtered and dried for two days at room temperature under vacuum. Meanwhile, the resulting filtrate was distilled to remove methanol and methylene chloride to yield a methanol soluble product.

The catalytic activity was calculated by dividing the mass of the yielded PPC with the mass of zinc containing in the said intercalating nano-catalyst

### EXAMPLE 1

Pretreatment of Vermiculite

The vermiculite (VMT) was first pretreated with hydrochloric acid as described in the literature. To a 1 L polypropylene beaker containing 800 mL of 2M HCl solution was added 25.0 g of 250 mesh crude VMT at room temperature. The resulting slurry was magnetically stirred for 12 h. The VMT was separated by filtration and then washed thoroughly with distilled water several times until the filtrate had a pH value of 7.0. After the washing, the obtained solid material was dried at 300° C. over night then calcinated at 1000° C. for 4 h.

Intercalation Reaction

1.0 g zinc succinate was dissolved in a 150 mL flask containing 100 mL water with a pH value of 2.0, then calcinated acidic VMT 3.0 g was introduced into the solution to perform intercalation at room temperature for 30 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL benzene and kept on refluxing 80° C. for 24 h. Then the final catalyst was separated by filtration and dried at 100° C. overnight

Evaluation of Catalytic Activity

Carefully weighed 2.0 g so-made catalyst and performed copolymerization as described above. The catalytic activity of this catalyst is 10.4 g polymer/g zinc.

### EXAMPLES 2-7

Pretreatment of Vermiculite

VMT was first pretreated with hydrochloric acid as described in the literature. To a 2 L polypropylene beaker containing 1600 mL of 2M HCl solution was added 50.0 g of 250 mesh crude VMT at room temperature. The resulting slurry was magnetically stirred for 12 h. The VMT was separated by filtration and then washed thoroughly with distilled water several times until the filtrate had a pH value of 7.0. After the washing, the obtained solid material was dried at 300° C. over night then calcinated at 900° C. for 4 h.

### EXAMPLE 2

Intercalation Reaction

1.0 g zinc glutarate was dissolved in a 150 mL flask containing 100 mL water with a pH value of 3.0, then calcinated acidic VMT 1.0 g was introduced into the solution to perform intercalation at room temperature for 60 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight

Evaluation of Catalytic Activity

Carefully weighed 2.0 g so-made catalyst and performed copolymerization as described above. The catalytic activity of this catalyst is 400.5 g polymer/g zinc.

### EXAMPLE 3

Intercalation Reaction

1.0 g zinc glutarate was dissolved in a 150 mL flask containing 100 mL water with a pH value of 3.0, then calcinated acidic VMT 2.0 g was introduced into the solution to perform intercalation at room temperature for 60 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight

Evaluation of Catalytic Activity

Carefully weighed 2.0 g so-made catalyst and performed copolymerization as described above. The catalytic activity of this catalyst is 405.8 g polymer/g zinc.

### EXAMPLE 4

Intercalation Reaction

1.0 g zinc glutarate was dissolved in a 150 mL flask containing 100 mL water with a pH value of 3.0, then calcinated acidic VMT 3.0 g was introduced into the solution to perform intercalation at room temperature for 60 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300-mL toulene and kept on refluxing at 110° C. for 24 h. Then the final catalyst was separated by filtration and dried at 100° C. overnight

Evaluation of Catalytic Activity

Carefully weighed 2.0 g so-made catalyst and performed copolymerization as described above. The catalytic activity of this catalyst is 410.8 g polymer/g zinc.

### EXAMPLE 5

Intercalation reaction

1.0 g zinc glutarate was dissolved in a 150 mL flask containing 100 mL water with a pH value of 3.0, then calcinated acidic VMT 5.0 g was introduced into the solution to perform intercalation at room temperature for 60 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight.

Evaluation of Catalytic Activity

Carefully weighed 2.0 g so-made catalyst and performed copolymerization as described above. The catalytic activity of this catalyst is 420.8 g polymer/g zinc.

### EXAMPLE 6

Intercalation Reaction

1.0 g zinc glutarate was dissolved in a 150 mL flask containing 100 mL water with a pH value of 3.0, then calcinated acidic VMT 10.0 g was introduced into the solution to perform intercalation at room temperature for 120 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight.

Evaluation of Catalytic Activity

Carefully weighed 4.0 g so-made catalyst and performed copolymerization as described above. The catalytic activity of this catalyst is 415.4 g polymer/g zinc.

### EXAMPLE 7

Intercalation Reaction

1.0 g zinc glutarate was dissolved in a 150 mL flask containing 100 mL water with a pH value of 3.0, then calcinated acidic VMT 20.0 g was introduced into the solution to perform intercalation at room temperature for 120 minutes. Then removed the solvent of this system and obtained crude inorganic intercalating nano-catalyst with VMT as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight

Evaluation of Catalytic Activity

Weighed 5.0 g so-made catalyst with analytic balance and performed copolymerization as described above. The catalytic activity of this catalyst is 403.8 g polymer/g zinc.

### EXAMPLE 8

Pretreatment of Montorillonite

The montorillonite was first pretreated with hydrochloric acid as described in the literature. To a 1 L polypropylene beaker containing 800 mL of 2M HCl solution was added 25.0 g of 250 mesh crude montorillonite at room temperature. The resulting slurry was magnetically stirred for 12 h. The montorillonite was separated by filtration and then washed thoroughly with distilled water several times until the filtrate had a pH value of 7.0. After the washing, the obtained solid material was dried at 300° C. over night then calcinated at 800° C. for 2 h.

Intercalation Reaction

1.0 g zinc adipate was dissolved in a 500 mL flask containing 400 mL water with a pH value of 4.0, then calcinated acidic montorillonite 3.0 g was introduced into the solution to perform intercalation at 60° C. for 60 minutes. Then removed the solvent of this system and obtained crude inorganic intercalating nano-catalyst with montorillonite as matrix.

Crystal Improving Process

Introduced the above obtained crude catalyst into a 500 mL flask with refluxing equipment containing 300 mL xylene and kept on refluxing at 138° C. for 24 h. Then the final catalyst was separated by filtration and dried at 100° C. overnight.

Evaluation of Catalytic Activity

Carefully weighed 2.0 g so-made catalyst and performed copolymerization as described above. The catalytic activity of this catalyst is 339.4 g polymer/g zinc.

### EXAMPLE 9

Pretreatment of Mica

The mica was first pretreated with hydrochloric acid as described in the literature. To a 1 L polypropylene beaker containing 800 mL of 2M HCl solution was added 25.0 g of 250 mesh crude mica at room temperature. The resulting slurry was magnetically stirred for 12 h. The mica was separated by filtration and then washed thoroughly with distilled water several times until the filtrate had a pH value of 7.0. After the washing, the obtained solid material was dried at 300° C. over night then calcinated at 750° C. for 2 h.

Intercalation Reaction

1.0 g zinc pimelate was dissolved in a 500 mL flask containing 400 mL water with a pH value of 4.0, then calcinated acidic mica 3.0 g was introduced into the solution to perform intercalation at 80° C. for 120 minutes. Then removed the solvent of this system and obtained crude inorganic intercalating nano-catalyst with mica as matrix.

Crystal Improving Process

Introduced the above obtained crude catalyst into a 500 mL flask with refluxing equipment containing 300 mL toulene and kept on refluxing at 110° C. for 24 h. Then the final catalyst was separated by filtration and dried at 100° C. overnight.

Evaluation of Catalytic Activity

Carefully weighed 2.0 g so-made catalyst and performed copolymerization as described above. The catalytic activity of this catalyst is 240.9 g polymer/g zinc.

### EXAMPLE 10

Pretreatment of Kaoline

The kaoline was first pretreated with hydrochloric acid as described in the literature. To a IL polypropylene beaker containing 800 mL of 2M HCl solution was added 25.0 g of 250 mesh crude kaoline at room temperature. The resulting slurry was magnetically stirred for 12 h. The kaoline was separated by filtration and then washed thoroughly with distilled water several times until the filtrate had a pH value of 7.0. After the washing, the obtained solid material was dried at 300° C. over night then calcinated at 600° C. for 4 h.

Intercalation Reaction

1.0 g zinc suberate was dissolved in a 500 mL flask containing 400 mL water with a pH value of 4.0, then calcinated acidic kaoline 3.0 g was introduced into the solution to perform intercalation at 60° C. for 60 minutes. Then removed the solvent of this system and obtained crude inorganic intercalating nano-catalyst with kaoline as matrix.

Crystal Improving Process

Introduced the above obtained crude catalyst into a 500 mL flask with refluxing equipment containing 300 mL benzene and kept on refluxing at 80° C. for 24 h. Then the final catalyst was separated by filtration and dried at 100° C. overnight.

Evaluation of Catalytic Activity

Carefully weighed 2.0 g so-made catalyst and performed copolymerization as described above. The catalytic activity of this catalyst is 128.8 g polymer/g zinc.

TABLE 1
Summary of the inorganic intercalating nano-catalysts and their catalytic activity

| | | | Matrix | Calcination | | | Catalytic activity |
|---|---|---|---|---|---|---|---|
| | Intercalating | Inorganic | content | condition | | Crystal improving | (g polymer.g |
| Example | agent | matrix | (%)* | (° C./hr) | Intercalating condition | conditions | zinc)** |
| 1 | Zinc succinate | Vermiculite, | 300 | 1000° C./ | Room temperature/30 min | benzene, 80° C. | 10.4 |
| | | | | 4 | | | |
| 2 | Zinc glutarate | Vermiculite | 100 | 900° C./4 | Room temperature/60 min | toluene, 110° C. | 400.5 |
| 3 | Zinc glutarate | Vermiculite | 200 | 900° C./4 | Room temperature/60 min | toluene, 110° C. | 405.8 |
| 4 | Zinc glutarate | Vermiculite | 300 | 900° C./4 | Room temperature/60 min | toluene, 110° C. | 410.8 |
| 5 | Zinc glutarate | Vermiculite | 500 | 900° C./4 | Room temperature/60 min | Toluene, 110° C. | 420.8 |
| 6 | Zinc glutarate | Vermiculite | 1000 | 900° C./4 | Rooim temperature/120 min | toluene, 110° C. | 415.4 |
| 7 | Zinc glutarate | Vermiculite | 2000 | 900° C./4 | Room temperature/120 min | toluene, 110° C. | 403.8 |
| 8 | Zinc adipate | Monmorilonite | 300 | 800° C./2 | 60° C./60 min | zylene, 138° C. | 339.4 |
| 9 | Zinc pimelate | mica | 300 | 750° C./2 | 80° C./120 min | toluene, 110° C. | 240.9 |
| 10 | Zinc suberate | kaoline | 300 | 600° C./4 | 60° C./60 min | Benzene, 80° C. | 128.8 |

**copolymerization condition: 60° C., 40 h, CO₂ pressure: 5.2 MPa.
*Inorganic content calculated based on intercalating agent.

We claim:

1. An inorganic intercalating nano-catalyst for the copolymerization of carbon dioxide and epoxide to form poly(alkylene carbonate) prepared by intercalating zinc dicarboxylate into matrix with layered structure.

2. The inorganic intercalating nano-catalyst of claim 1 wherein the weight ratio of said zinc dicarboxylate to said inorganic matrix is from 1/1 to 1/20.

3. The inorganic intercalating nano-catalyst of claim 1 wherein said intercalating agent zinc dicarboxylates are selected from the group consisting of zinc succinate, zinc glutarate, zinc adipate, zinc pimelate and zinc suberate, and the mixture thereof.

4. The catalyst of claim 1 wherein said inorganic matrices are selected from the group of inorganic mineral particles with layered structure consisting of montmorillonite, mica, vermiculite and kaoline.

5. A process for preparation of a inorganic intercalating nano-catalyst for the copolymerization of carbon dioxide and epoxides to form poly(alkylene carbonate)s comprising:
delaminating the layered matrix with diluted acid, then calcining at 600-1000° C. in a muffle furnace for 2˜10 h prior to intercalation;
dissolving zinc dicarboxylate in strong polar solvent under pH value from 1.0 to 4.0, then introducing calcinated acidic matrix into the reaction system to perform intercalation 30˜120 minutes at the temperature from room temperature to 80° C.; and
removing the solvent and improving the crystal of the intercalating nano-catalyst by refluxing in less polar solvent.

6. The process of claim 5 wherein said strong polar solvents are selected from the group consisting of methanol, glycol, ethylene glycol monobutyl ether, ethylene glycol monomethyl ether, N,N′-dimethyl formamide, sulfolane, imidazole, quinoline, water and N-cyclohexyl pyrrolidine; and adjusting pH value from 1.0 to 4.0 with diluted acid.

7. The process of claim 5 wherein said less polar solvents are selected from the group consisting of benzene, toluene and xylene.
